(19) United States
(12) Patent Application Publication
(10) Pub. No.: US 2016/0266789 A1
(43) Pub. Date: Sep. 15, 2016

(54) TOUCH INPUT DEVICE AND METHOD

(71) Applicant: SHENZHEN CHINA STAR OPTOELECTRONICS TECHNOLOGY CO., LTD., Shenzhen, Guangdong (CN)

(72) Inventors: Jie QIU, Shenzhen, Guangdong (CN); Yung-lun LIN, Shenzhen, Guangdong (CN); Ruhai FU, Shenzhen, Guangdong (CN); Chengliang YE, Shenzhen, Guangdong (CN); Chun-kai CHANG, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/407,456

(22) PCT Filed: Nov. 21, 2014
(86) PCT No.: PCT/CN2014/091888

§ 371 Date: Dec. 11, 2014

(30) Foreign Application Priority Data
Nov. 14, 2014 (CN) 201410650117.4

(51) Int. Cl. G06F 3/0488; G06F 1/16; G06F 3/041

(52) U.S. Cl. CPC G06F 3/04886; G06F 3/04883; G06F 3/0416; G06F 1/1692; G06F 2203/04104

(57) ABSTRACT

The present invention discloses a touch input device and a method. The touch input device comprises a main touch screen located to be attached with a primary surface of the touch input device, a minor touch screen located to be attached with a lateral surface of the touch input device and a main control module coupled to the main touch screen and the minor touch screen; wherein the main control module controls the minor touch screen to show a plurality of auxiliary touch buttons, and the touch input device further comprises a main touch button, and the main touch button is employed for activating and deactivating touch control function of the plurality of auxiliary touch buttons. Accordingly, the present invention can activate the auxiliary touch buttons when the user demands and deactivate the auxiliary touch buttons as not demanded to prevent misoperation for the user's convenience.

### FIELD OF THE INVENTION

The present invention relates to a liquid crystal display field, and more particularly to a touch input device and a manufacture method thereof.

### BACKGROUND OF THE INVENTION

The touch screen only needs an user to touch the display screen with fingers. The operation to the terminal can be achievable to make the interaction between the human and machine smoother. The application scope of the touch screen can be very wide, such as personal products, the cellphone, the tablets, and public services, the business queries of the banks.

With the development of the mobile terminals and the touch screens, the display screen of the terminal continuously grows larger and thinner. However, as considering the dimension, the beauty of the whole terminal, the side frame constantly needs to be narrower and narrower.

Because the side frame becomes narrower, the user may input the touch information triggered by careless touches when the user holds the terminal with a hand but does not wants any input operations. The issue of the misoperation occurs. Particularly, under circumstance that the terminal comprises a display screen at the lateral side, the user merely holds the terminal, the touch to the lateral side of the terminal becomes unavoidable to result in misoperation.

### SUMMARY OF THE INVENTION

The technical issue to be solved by the present invention is to provide a touch input device and a method which can activate the auxiliary touch buttons when the user demands and deactivate the auxiliary touch buttons as not demanded to prevent misoperation for the user's convenience.

For solving the aforesaid technical issue, the technical solution employed by the present invention is: to provide a touch input device, and the touch input device comprises a main touch screen located to be attached with a primary surface of the touch input device, a minor touch screen located to be attached with a lateral surface of the touch input device and a main control module coupled to the main touch screen and the minor touch screen;

wherein the main control module controls the minor touch screen to show a plurality of auxiliary touch buttons, and the touch input device further comprises a main touch button, and the main touch button is employed for activating and deactivating touch control function of the plurality of auxiliary touch buttons;

wherein the primary surface and the lateral surface are setup perpendicularly or setup of tilting with a predetermined angle in between.

The main control module confirms a holding area of an user to the touch input device according to a touch control motion of the user accommodated by the main touch screen or the minor touch screen, and dynamically adjusts a display location of the auxiliary touch buttons according to the holding area.

The main control module controls the minor touch screen to show the plurality of auxiliary touch button, and the touch input device further comprises a main touch button, and the main touch button is employed for activating and deactivating touch control function of the plurality of auxiliary touch buttons.

The main control module controls the minor touch screen or the main touch screen to show the main touch button.

The main touch button is shown on the minor touch screen at a location deactivate to the top of the touch input device.

The main control module further confirms whether a duration of the touch control motion is larger than or equal to a threshold after accommodating the touch control motion of the user by the main touch screen or the minor touch screen, and the touch control motion is determined to be a invalid touch if the duration is larger than or equal to the threshold and no response is made to the touch control motion, and the touch control motion is determined to be a valid touch if the duration is smaller than the threshold and a response is made to the touch control motion.

For solving the aforesaid technical issue, a technical solution employed by the present invention is: to provide a touch input device, and the touch input device comprises a main touch screen located to be attached with a primary surface of the touch input device, a minor touch screen located to be attached with a lateral surface of the touch input device and a main control module coupled to the main touch screen and the minor touch screen;

wherein the main control module controls the minor touch screen to show a plurality of auxiliary touch buttons, and the touch input device further comprises a main touch button, and the main touch button is employed for activating and deactivating touch control function of the plurality of auxiliary touch buttons.

The main control module controls the minor touch screen or the main touch screen to show the main touch button.

The main touch button is shown on the minor touch screen at a location deactivate to the top of the touch input device.

The main control module further confirms whether a duration of the touch control motion is larger than or equal to a threshold after accommodating the touch control motion of the user by the main touch screen or the minor touch screen, and the touch control motion is determined to be a invalid touch if the duration is larger than or equal to the threshold and no response is made to the touch control motion, and the touch control motion is determined to be a valid touch if the duration is smaller than the threshold and a response is made to the touch control motion.

The primary surface and the lateral surface are setup perpendicularly or setup of tilting with a predetermined angle in between.

The main control module confirms a holding area of an user to the touch input device according to a touch control motion of the user accommodated by the main touch screen or the minor touch screen, and dynamically adjusts a display location of the auxiliary touch buttons according to the holding area.

For solving the aforesaid technical issue, a technical solution employed by the present invention is: to provide a touch input method, and the touch input method comprises: showing a plurality of auxiliary touch buttons; employing a main touch button to activate and deactivate touch control function of the plurality of auxiliary touch buttons.

The step of employing a main touch button to activate and deactivate touch control function of the plurality of auxiliary touch buttons comprises: showing the main touch button; activating and deactivating touch control function of the plurality of auxiliary touch buttons in response to the touch control motion of the main touch button.

The touch input device comprises a main touch screen located to be attached with a primary surface of the touch input device, a minor touch screen located to be attached with a lateral surface of the touch input device; the step of showing the plurality of auxiliary touch buttons comprises: controlling the minor touch screen to show the auxiliary touch buttons.

The step of controlling the minor touch screen to show the auxiliary touch buttons further comprises: confirming a holding area of an user to the touch input device according to a touch control motion of the user accommodated by the main touch screen or the minor touch screen, and dynamically adjusting a display location of the auxiliary touch buttons according to the holding area.

The benefits of the present invention are: different from the prior arts, the present invention employs the main control module to control the minor touch screen located to be attached with the lateral surface of the touch input device for showing the plurality of auxiliary touch buttons. The main touch button of the touch input device can activate and deactivate the touch control function of the plurality of auxiliary touch buttons. When the user demands the auxiliary touch buttons, the main touch button can be clicked to activate the touch control function of the plurality of auxiliary touch buttons. The touch control function of the auxiliary touch buttons can be deactivated as not demanded by the user to prevent trouble brought by the misoperation of the finger touch during the operation of the user.

### BRIEF DESCRIPTION OF THE DRAWINGS

FIG. 1 is a structural diagram of a touch input device according to the first embodiment of the present invention;

FIG. 2 is another structural diagram of the touch input device according to the first embodiment of the present invention;

FIG. 3 is an explosive structural diagram of the touch input device according to the first embodiment of the present invention;

FIG. 4 is a front view diagram of the touch input device according to the first embodiment of the present invention;

FIG. 5 is a structural diagram of a touch input device according to the second embodiment of the present invention;

FIG. 6 is a flowchart of the touch input device according to the second embodiment of the present invention;

FIG. 7 is a structural diagram of a touch input device according to the third embodiment of the present invention;

FIG. 8 is a flowchart of a touch input method according to the first embodiment of the present invention;

FIG. 9 is a flowchart of a touch input method according to the second embodiment of the present invention;

### DETAILED DESCRIPTION OF PREFERRED EMBODIMENTS

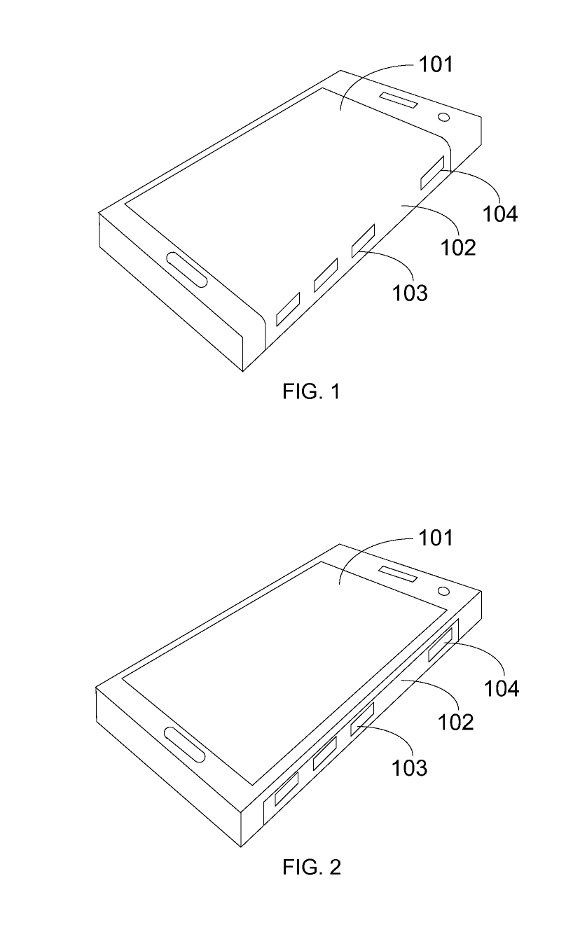

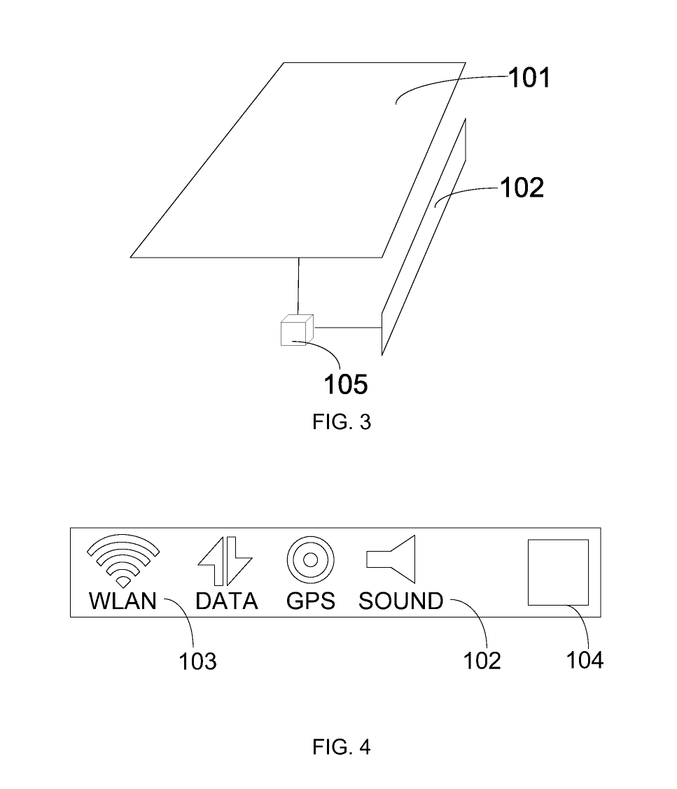

Please refer to FIG. 1, which is a structural diagram of a touch input device according to the first embodiment of the present invention. The touch input device comprises a main touch screen 101 located to be attached with a primary surface of the touch input device, a minor touch screen 102 located to be attached with a lateral surface of the touch input device and a main control module 105 coupled to the main touch screen 101 and the minor touch screen 102 (as shown in FIG. 3);

wherein the main control module 105 controls the minor touch screen 102 to show a plurality of auxiliary touch buttons 103, and the touch input device further comprises a main touch button 104, and the main touch button 104 is employed for activating and deactivating touch control function of the plurality of auxiliary touch buttons 103.

The main touch screen 101 and the minor touch screen 102 can be two different surfaces of an one body shaped curved display as shown in FIG. 1. Alternatively, it can be two different displays, the main touch screen 101 and the minor touch screen 102, respectively located at the primary surface and the lateral surface of the touch input device; besides, the minor touch screen 102 can be located at either of the lateral surfaces according to the habits of the user or on the actual demands. The size of the minor touch screen 102 can be set on demands.

Please refer to both of FIG. 1 and FIG. 2. The main control module 105 controls the minor touch screen 102 or the main touch screen 101 to show the main touch button 104.

The main touch button 104 generally is located where the user would not easily touch, such as the top of the main touch screen 101 or the minor touch screen 102 because the main touch button 104 is functioned for activating and deactivating the plurality of auxiliary touch buttons 103 to prevent the misoperation as the auxiliary touch buttons are not demanded for the user. Alternatively, the main touch button 104 can be located at the lateral side of the top in a way of mechanical button; in a preferable embodiment, the main touch button 104 can be shown on the minor touch screen 102 at a location close to the top of the touch input device.

Moreover, multiple minor display screens can be located at a plurality of lateral sides of the touch input device. For instance, two minor touch screens can be respectively located at left and right sides of the touch input device. The main touch button 104 and the plurality of auxiliary touch buttons 103 can be respectively located on the different minor touch screen for operation convenience.

Please refer to FIG. 4, the auxiliary touch buttons 103 of the minor touch screen 102 can show some function buttons in FIG. 3, such as WLAN, GPS, Bluetooth, et cetera or some commonly used application software; the main touch button 104 can be located at a location close to the top of the touch input device where is away from the location of the auxiliary touch buttons 103.

Different from the prior arts, the present invention employs the main control module 105 to control the minor touch screen located to be attached with the lateral surface of the touch input device for showing the plurality of auxiliary touch buttons. The main touch button of the touch input device can activate and deactivate the touch control function of the plurality of auxiliary touch buttons. When the user demands the auxiliary touch buttons, the main touch button can be clicked to activate the touch control function of the plurality of auxiliary touch buttons. The touch control function of the auxiliary touch buttons can be deactivated as not demanded by the user to prevent trouble brought by the misoperation of the finger touch during the operation of the user.

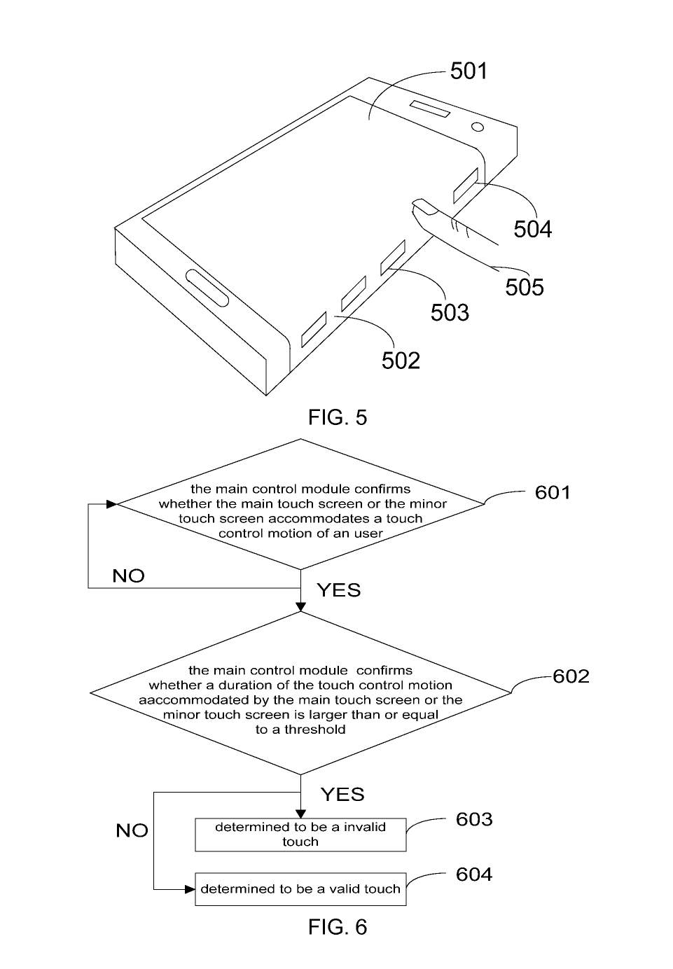

Please refer to FIG. 5, which is a structural diagram of a touch input device according to the second embodiment of the present invention. The touch input device comprises a main touch screen 501 located to be attached with a primary surface of the touch input device, a minor touch screen 502 located to be attached with a lateral surface of the touch input device and a main control module coupled to the main touch screen 501 and the minor touch screen 502;

wherein the main control module controls the minor touch screen 502 to show a plurality of auxiliary touch buttons 503, and the touch input device further comprises a main touch button 504, and the main touch button 504 is employed for activating and deactivating touch control function of the plurality of auxiliary touch buttons 503.

Besides, the main control module further confirms whether a duration of the touch control motion is larger than or equal to a threshold after accommodating the touch control motion of the user by the main touch screen 501 or the minor touch screen 502, and the touch control motion is determined to be a invalid touch if the duration is larger than or equal to the threshold and no response is made to the touch control motion, and the touch control motion is determined to be a valid touch if the duration is smaller than the threshold and a response is made to the touch control motion.

The main touch screen 501 and the minor touch screen 502 are setup perpendicularly or the surfaces of the two touch screens are setup of tilting with a predetermined angle in between. When the main touch screen 501 and the minor touch screen 502 are setup perpendicularly, a curved display screen can be employed for connecting the two screens.

Please refer to FIG. 6. The specific implement steps of this embodiment are:

Step 601, the main control module confirms whether the main touch screen or the minor touch screen accommodates a touch control motion of an user; if yes, then proceeds to step 602; if no, then repeats the step 601;

Step 602, the main control module further confirms whether a duration of the touch control motion accommodated by the main touch screen or the minor touch screen is larger than or equal to a threshold; if yes, then proceeds to step 603; if no, then proceeds to step 604;

Step 603, determined to be an invalid touch;

Step 604, determined to be a valid touch;

Besides, as regarding of activating or deactivating the auxiliary touch button with the main touch button and confirming whether the touch control motion is valid or not by confirming the duration of the touch, these two setting can be implemented as two independent confirming operations. Alternately, these two settings can be combined as one implement of multiple confirmations. For instance, first, activating with the main touch button and then confirming whether the touch control motion is valid or not by detecting the duration of the touch can be illustrated.

Different from the prior arts, this embodiment adds the operation of confirming the duration of touch control motion on the basis of the first embodiment. By detecting whether the duration of the touch control motion is larger than or equal to a threshold for determining whether it is a valid touch or not. With these two settings to prevent the misoperation of the user. It can make the user more comfortable in the operation without worrying about the trouble brought by the misoperation.

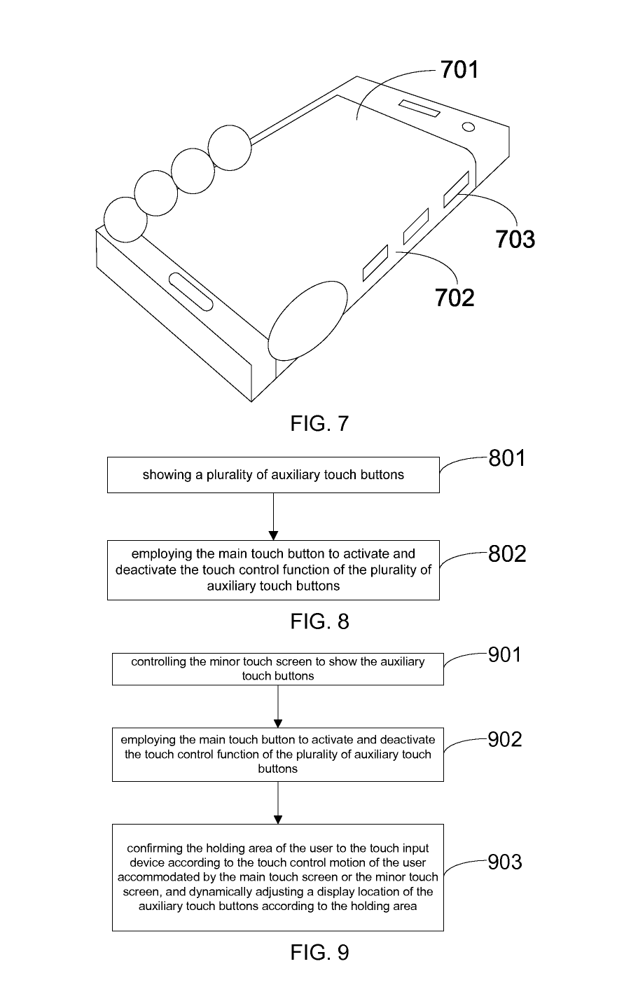

Please refer to FIG. 7, which is a structural diagram of a touch input device according to the second embodiment of the present invention. The touch input device comprises a main touch screen 701 located to be attached with a primary surface of the touch input device, a minor touch screen 702 located to be attached with a lateral surface of the touch input device and a main control module coupled to the main touch screen 701 and the minor touch screen 702 (not shown);

wherein the main control module controls the minor touch screen 702 to show a plurality of auxiliary touch buttons 703, and the touch input device further comprises a main touch button 704, and the main touch button 704 is employed for activating and deactivating touch control function of the plurality of auxiliary touch buttons 703.

Moreover, the main control module confirms a holding area of an user to the touch input device according to a touch control motion of the user accommodated by the main touch screen 701 or the minor touch screen 702, and dynamically adjusts a display location of the auxiliary touch buttons 703 according to the holding area.

The holding area of the user to the touch input device can be confirmed by utilizing the second embodiment of detecting whether the duration of the touch control motion is larger than or equal to a threshold. When the durations of multiple touch control positions are larger or equal to the threshold, the holding area of the user can be determined thereby. The threshold can be the same as the previously mentioned threshold. Alternately, another threshold can be employed for setting.

Specifically, as shown in FIG. 6, when the main control module determines that the lower part of the terminal is the holding area, the location showing auxiliary touch buttons 703 is adjusted to the top of the terminal, i.e. the area that the user is not holding.

Besides, in this embodiment, the setting of adjusting the location of showing the auxiliary touch buttons 703 according to the holding area of the user can be co-exist with the previous embodiment. Alternately, it can be a solo embodiment. No limitation is required herewith.

Different from the prior arts, the main control module of this embodiment confirms the holding area of the user to the touch input device according to the touch control motion of the user accommodated by the main touch screen or the minor touch screen, and dynamically adjusts the display location of the auxiliary touch buttons according to the holding area. The display location of the auxiliary touch buttons can be intelligently adjusted without any manual operations to prevent the inconvenience caused by that the user accidentally push the wrong auxiliary touch buttons and to make more convenient to the user for his operation to the auxiliary touch buttons outside the holding area.

Please refer to FIG. 8, which is a flowchart of a touch input method according to the first embodiment of the present invention, and the method comprises the following steps:

Step 801, showing a plurality of auxiliary touch buttons;

Step 802, employing the main touch button to activate and deactivate the touch control function of the plurality of auxiliary touch buttons.

This implement is one of the embodiments of the aforesaid touch input device. The specific context is similar to the foregoing embodiment. The repeated description is omitted here.

Please refer to FIG. 9, which is a flowchart of a touch input method according to the second embodiment of the present invention, and the method comprises the following steps:

Step 901, controlling the minor touch screen to show the auxiliary touch buttons;

Step 902, employing the main touch button to activate and deactivate the touch control function of the plurality of auxiliary touch buttons;

Step 903, confirming the holding area of the user to the touch input device according to the touch control motion of the user accommodated by the main touch screen or the minor touch screen, and dynamically adjusting the display location of the auxiliary touch buttons according to the holding area.

This implement is one of the embodiments of the aforesaid touch input device. The specific context is similar to the foregoing embodiment. The repeated description is omitted here.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A touch input device, wherein the touch input device comprises a main touch screen located to be attached with a primary surface of the touch input device, a minor touch screen located to be attached with a lateral surface of the touch input device and a main control module coupled to the main touch screen and the minor touch screen;
wherein the main control module controls the minor touch screen to show a plurality of auxiliary touch buttons, and the touch input device further comprises a main touch button, and the main touch button is employed for activating and deactivating touch control function of the plurality of auxiliary touch buttons;
the primary surface and the lateral surface are setup perpendicularly or setup of tilting with a predetermined angle in between.

2. The touch input device according to claim 1, wherein the main control module confirms a holding area of an user to the touch input device according to a touch control motion of the user accommodated by the main touch screen or the minor touch screen, and dynamically adjusts a display location of the auxiliary touch buttons according to the holding area.

3. The touch input device according to claim 1, wherein the main control module controls the minor touch screen or the main touch screen to show the main touch button.

4. The touch input device according to claim 2, wherein the main touch button is shown on the minor touch screen at a location close to the top of the touch input device.

5. The touch input device according to claim 1, wherein the main control module further confirms whether a duration of the touch control motion is larger than or equal to a threshold after accommodating the touch control motion of the user by the main touch screen or the minor touch screen, and the touch control motion is determined to be a invalid touch if the duration is larger than or equal to the threshold and no response is made to the touch control motion, and the touch control motion is determined to be a valid touch if the duration is smaller than the threshold and a response is made to the touch control motion.

6. A touch input device, wherein the touch input device comprises a main touch screen located to be attached with a primary surface of the touch input device, a minor touch screen located to be attached with a lateral surface of the touch input device and a main control module coupled to the main touch screen and the minor touch screen;
wherein the main control module controls the minor touch screen to show a plurality of auxiliary touch buttons, and the touch input device further comprises a main touch button, and the main touch button is employed for activating and deactivating touch control function of the plurality of auxiliary touch buttons.

7. The touch input device according to claim 6, wherein the main control module controls the minor touch screen or the main touch screen to show the main touch button.

8. The touch input device according to claim 6, wherein the main touch button is shown on the minor touch screen at a location close to the top of the touch input device.

9. The touch input device according to claim 6, wherein the main control module further confirms whether a duration of the touch control motion is larger than or equal to a threshold after accommodating the touch control motion of the user by the main touch screen or the minor touch screen, and the touch control motion is determined to be a invalid touch if the duration is larger than or equal to the threshold and no response is made to the touch control motion, and the touch control motion is determined to be a valid touch if the duration is smaller than the threshold and a response is made to the touch control motion.

10. The touch input device according to claim 6, wherein the primary surface and the lateral surface are setup perpendicularly or setup of tilting with a predetermined angle in between.

11. The touch input device according to claim 6, wherein the main control module confirms a holding area of an user to the touch input device according to a touch control motion of the user accommodated by the main touch screen or the minor touch screen, and dynamically adjusts a display location of the auxiliary touch buttons according to the holding area.

12. A control method of a touch input device, wherein the control method comprises:
showing a plurality of auxiliary touch buttons;
employing a main touch button to activate and deactivate touch control function of the plurality of auxiliary touch buttons.

13. The control method according to claim 12, wherein the step of employing a main touch button to activate and deactivate touch control function of the plurality of auxiliary touch buttons comprises:
showing the main touch button;
activating and deactivating touch control function of the plurality of auxiliary touch buttons in response to the touch control motion of the main touch button.

14. The control method according to claim 12 or 13, wherein the touch input device comprises a main touch screen located to be attached with a primary surface of the touch input device, a minor touch screen located to be attached with a lateral surface of the touch input device;
the step of showing the plurality of auxiliary touch buttons comprises:
controlling the minor touch screen to show the auxiliary touch buttons.

15. The control method according to claim 14, wherein the step of controlling the minor touch screen to show the auxiliary touch buttons further comprises:
confirming a holding area of an user to the touch input device according to a touch control motion of the user accommodated by the main touch screen or the minor touch screen, and dynamically adjusting a display location of the auxiliary touch buttons according to the holding area.
